(19) United States
(12) Patent Application Publication
(10) Pub. No.: US 2006/0039154 A1
(43) Pub. Date: Feb. 23, 2006

(54) Lighting device

(75) Inventor: Johannes Marra, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 10/526,926

(22) PCT Filed: Sep. 1, 2003
(86) PCT No.: PCT/IB03/03852

§ 371 Date: Mar. 8, 2005

(30) Foreign Application Priority Data
Sep. 12, 2002 (EP) 02078758.6

(51) Int. Cl. F21V 5/00

(52) U.S. Cl. 362/330; 362/327

(57) ABSTRACT

A lighting device comprising at least one light source arranged in a housing for emitting a lighting beam through a light-transmitting plate of the housing, wherein said plate (1) is provided with means which reflect incident light on the plate (1), in such a manner that light which locally has a higher intensity is reflected more strongly at that location than light which locally has a lower intensity, a special feature being the fact that said means comprise at least one light-transmitting plate, which is locally provided with a patterned reflective material, the reflective material reflecting more than 80% of the incident

The invention relates to a lighting device comprising at least one light source arranged in a housing for emitting a lighting beam through a light-transmitting plate of the housing, wherein said plate is provided with means which reflect incident light on the plate, in such a manner that light which locally has a higher intensity is reflected more strongly at that location than light which locally has a lower intensity.

Such a lighting device is generally known. The known lighting device is usually a flat light box, such as the light box that is used for the visual inspection of x-ray photographs, for realising flat lighting tiles or lighting walls attached to walls or ceilings for general lighting purposes, or for backlighting advertising columns, billboards, or LCD screens. As a rule, the at least one light source that is present in the light box is at least partly surrounded by a reflector for reflecting the light emitted by the light source in a direction away from the light-transmitting plate back to the light-transmitting plate. An important practical requirement concerning such products is that the light exiting from the light-transmitting plate must exhibit a substantially homogeneous intensity over substantially the entire plate area, so that the location and the shape of the light source—for example in the form of one or more TL tubes in the case of a light box—cannot be distinguished as such from the outside. In order to accomplish this, it is known to apply a coating having a locally varying thickness, usually consisting of light-diffusing inorganic particles dispersed in an organic binder matrix, to the entire light-transmitting plate, for instance by spraying. The locally varying thickness causes the optical reflection of incident light on the plate to vary locally, wherein a coating which is locally relatively thicker effects a higher degree of reflection at the location in question than a coating which is locally relatively thinner. Consequently, the local variation in thickness in the coating must be selected so that the coating reflects incident light on the plate in such a manner that light which locally has a higher intensity is reflected more strongly by the coating at the location in question than light which locally has a lower intensity.

One drawback of the known lighting device is the fact that, in particular in the case of very flat light boxes, the required lateral thickness profile of the coating on the plate must exhibit a lateral thickness gradient which is so large and which, moreover, has been adjusted so precisely in order to effect the desired reflection/transmission gradient over the entire light-transmitting plate, that, in practice, it is not possible to apply such a coating sufficiently reliably and efficiently.

The object of the invention is to overcome this drawback of the prior art, and in order to accomplish that objective a lighting device of the kind according to the invention as referred to in the introduction is characterized in that said means comprise at least one light-transmitting plate, which is locally provided with a patterned reflective material, the provided reflective material reflecting more than 80% of the incident light thereon. Said material may be arranged in a one-dimensional pattern or in a two-dimensional pattern. In the latter case, a two-dimensional pattern of lines and/or grooves provided with the reflective material is used, for example, wherein lines and/or grooves intersect so as to form a two-dimensional network, or wherein separate, possibly interconnected two-dimensional patterns, such as small squares or rectangles are provided with the reflective material. Preferably, practically no reflective material is present on the parts of the surface present between the patterned reflective material on the plate. The reflective material is in particular a specular reflective material, preferably selected from the group of metals consisting of aluminium and silver. More in particular, the reflective material is a diffuse reflective powder, whilst it may also consist of diffuse reflective particles in a so-called “binder matrix”, whether or not in combination with each other and/or in combination with a specular reflective material. Experiments have shown that a patterned reflective material can readily be provided on the plate, the provided reflective material having a reflectivity of more than 80%, i.e. yielding a transmission of less than 20%, with a relatively higher pattern density at those locations where the intensity of the incident light is higher and a relatively lower pattern density at those locations where the intensity of the incident light is lower, and wherein the individual patterns have been rendered visually indistinguishable by disposing an additional translucent plate, for example a matted plate, on the side of the light-transmitting plate facing away from the light source, spaced from said light-transmitting plate by a short distance and oriented in parallel thereto. The visual effect that is achieved therewith is that the light emitted by the lighting device has a laterally homogeneous intensity.

In one preferred embodiment of a lighting device according to the invention, said means comprise at least one light-transmitting plate having grooves formed therein, which grooves are filled with a diffuse reflective powder. In particular, grooves present at locations where the incident light on the plate has a higher intensity are wider than grooves present at locations where the incident light on the plate has a lower intensity, whilst in another preferred variant the spacing between neighbouring grooves is smaller at locations here the incident light on the plate has a higher intensity than at locations where the incident light on the plate has a lower intensity. Thus, an average homogeneous intensity of light exiting from the light-transmitting plate is realised, in which the individual patterns have been rendered visually indistinguishable by disposing an additional translucent plate, for example a matted plate, on the side of the light-transmitting plate facing away from the light source, spaced from said light-transmitting plate by a short distance and oriented in parallel thereto.

In another preferred embodiment of a lighting device according to the invention, the grooves are formed in the light-transmitting plate of the housing, wherein the grooves are covered by a cover plate arranged on said plate.

In one preferred embodiment of a lighting device according to the invention, the grooves are formed in a light-transmitting second plate arranged on the light-transmitting plate of the housing, wherein the grooves in the second plate are covered by a cover plate arranged on said second plate. In another preferred variant, the grooves are formed in a light-transmitting second plate arranged on the light-transmitting plate of the housing, wherein the grooves are covered by the plate of the housing.

In another preferred embodiment of a lighting device according to the invention, the grooves have a minimum depth of at least 1.5 mm and a minimum width of at least 1 mm.

In another preferred embodiment of a lighting device according to the invention, the powder comprises calcium halophosphate, calcium pyrophosphate, BaSO₄, MgO, YBO₃, TiO₂ or Al₂O₃ particles. Such a powder is physically resistant against high temperatures, whilst important chemical properties thereof do not deteriorate as a result of being exposed to high temperatures, light and/or moisture. The powder is in particular a “free-flowing” type powder.

In another preferred embodiment of a lighting device according to the invention, the particles have an average diameter ranging from 0.1 to 100 □m, in particular from 5 to 20 □m. In order to obtain a “free-flowing” type powder, said particles are preferably mixed with fine-grained Al₂O₃ particles having an average diameter which ranges from 10 to 50 nm. The amount of the latter fine-grained particles, also known as Alon-C (Degussa, Frankfurt), preferably ranges from 0.1 to 5 wt. %, in particular from 0.5 to 3 wt. %.

In another preferred embodiment of a lighting device according to the invention, the powder is substantially incapable of absorbing light, in particular light having a wavelength in the visible wavelength range. Any loss of light in this wavelength range due to absorption is thus prevented.

The invention also relates to a method for the lateral homogenisation of the intensity of the light emitted from a lighting housing, using a lighting device comprising at least one light source arranged in a housing for emitting a lighting beam through a light-transmitting plate of the housing, wherein said plate is locally provided with means which reflect incident light on the plate, in such a manner that light which locally has a higher intensity is reflected more strongly at that location than light which locally has a lower intensity, characterized in that said means comprise at least one light-transmitting plate, which is locally provided with a material which reflects more than 80% of the incident light thereon, and wherein the patterned material has been rendered visually indistinguishable by disposing an additional translucent plate, for example a matted plate, on the side of the light-transmitting plate facing away from the light source, spaced from said light-transmitting plate by a short distance and oriented in parallel thereto.

The invention will not be explained in more detail with reference to figures illustrated in the drawings, in which:

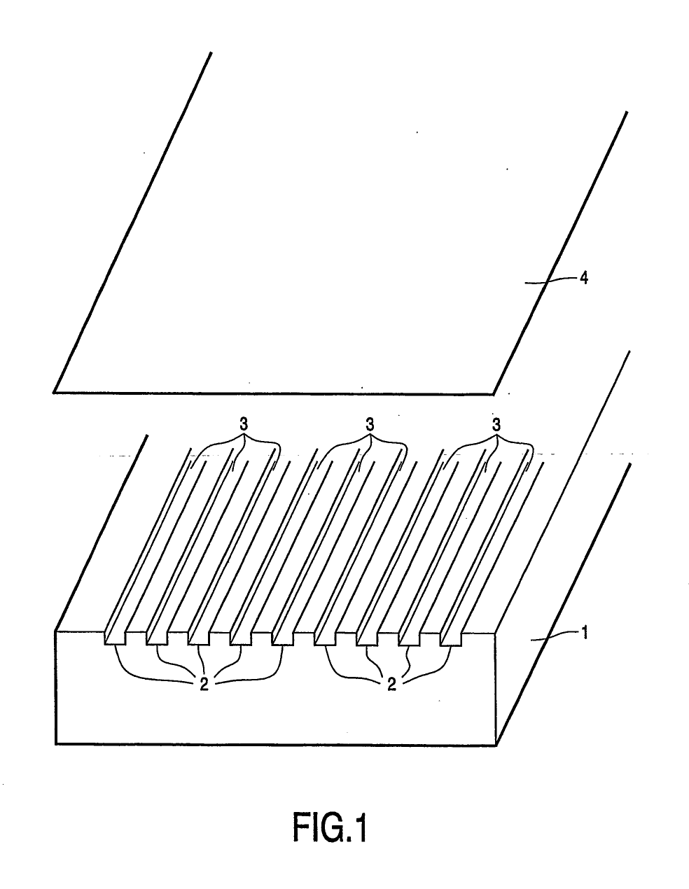

FIG. 1 is a schematic, perspective view of a part of a light box according to the invention; and

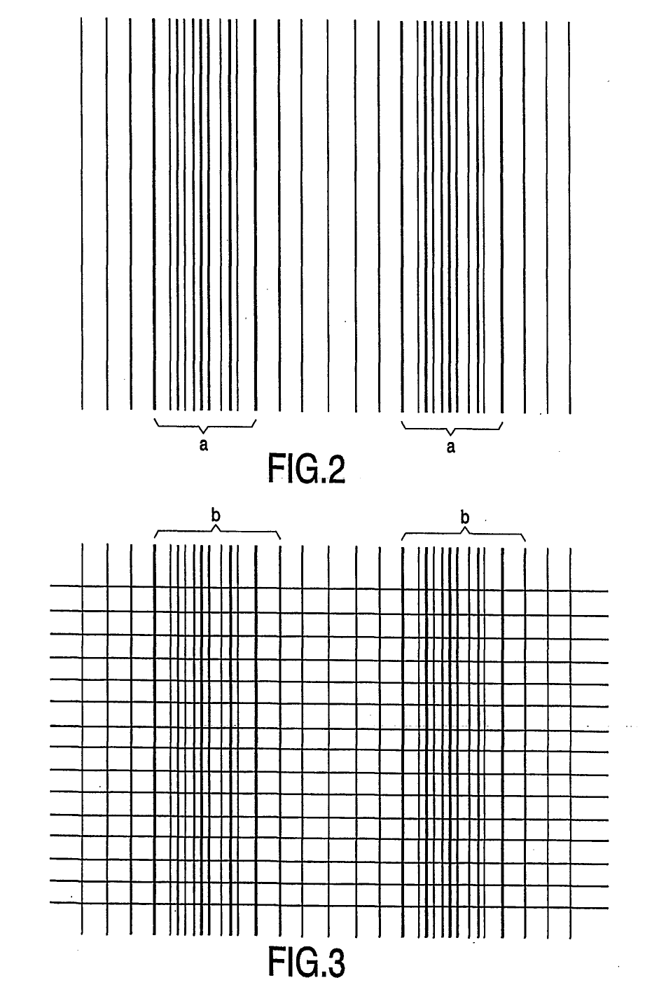

FIGS. 2 and 3 are schematic top plan views of the light box of FIG. 1, in which the diffuse reflective material is present in various patterns, however.

FIG. 1 shows a light-transmitting glass or plastic plate 1, which is mounted on a light box (not shown). In order to ensure that TL-tubes (not shown) in the light box cannot be individually distinguished from the outside, incident light on the plate 1 coming from the TL-tubes must be made to exit the plate 1 with a homogeneous intensity over the entire area of the plate. To this end, longitudinal grooves 2 are formed in the plate 1 in parallel with the orientation direction of the TL-tubes in the light box, and these grooves are provided with a diffuse reflective powder 3. Said powder 3 is a “free-flowing” type powder, comprising calcium halophosphate, calcium pyrophosphate, BaSO₄, MgO, YBO₃, TiO₂ or Al₂O₃ particles. The effect of said particles is that incident light on the light-transmitting plate 1 is diffuse reflected. By making the grooves 2 locally wider than elsewhere, and/or by using a locally smaller spacing between adjacent grooves 2, light which locally has a higher intensity will be reflected more strongly at that location than light which locally has a lower intensity. In order to ensure that the powder 3 cannot move out of the grooves 2, a glass cover plate 4 is arranged on the plate 1.

FIGS. 2 and 3 show various patterns, viz. a one-dimensional pattern (FIG. 2) and a two-dimensional pattern (FIG. 3), in which the grooves 2 are formed in the plate 1. TL tubes are placed and positioned in the light box such as to directly face the areas “a” (FIG. 2) and the areas “b” FIG. 3) of the light-transmitting plate 1. The individual patterns are rendered visually indistinguishable by disposing an additional translucent plate, for example a matted plate, on the side of the light-transmitting plate facing away from the light source, spaced from said light-transmitting plate by a short distance and oriented in parallel thereto.

1. A lighting device comprising at least one light source arranged in a housing for emitting a lighting beam through a light-transmitting plate of the housing, wherein said plate is provided with means which reflect incident light on the plate, in such a manner that light which locally has a higher intensity is reflected more strongly at that location than light which locally has a lower intensity, characterized in that said means comprise at least one light-transmitting plate, which is locally provided with a patterned reflective material, the provided reflective material reflecting more than 80% of the incident light thereon.

2. A lighting device according to claim 1, wherein said material is arranged in a one-dimensional spatial pattern on or in the light-transmitting plate.

3. A lighting device according to claim 1, wherein said material is arranged in a two-dimensional spatial pattern on or in the light-transmitting plate.

4. A lighting device according to claim 1, wherein said means comprise at least one light-transmitting plate having grooves formed therein, which grooves are filled with a diffuse reflective powder.

5. A lighting device according to claim 4, wherein grooves present at locations where the incident light on the plate has a higher intensity are wider than grooves present at locations where the incident light on the plate has a lower intensity.

6. A lighting device according to claim 4, wherein the spacing between neighbouring grooves is smaller at locations where the incident light on the plate has a higher intensity than at locations where the incident light on the plate has a lower intensity.

7. A lighting device according to claim 4, wherein the grooves are formed in the light-transmitting plate of the housing, and wherein the grooves are covered by a cover plate arranged on said plate.

8. A lighting device according to claim 4, wherein the grooves are formed in a light-transmitting second plate arranged on the light-transmitting plate of the housing, and wherein the grooves in the second plate are covered by a cover plate arranged on said second plate.

9. A lighting device according to claim 4, wherein the grooves are formed in a light-transmitting second plate arranged on the light-transmitting plate of the housing, and wherein the grooves are covered by the plate of the housing.

10. A lighting device according to claim 4, wherein said grooves have a minimum depth of at least 1.5 mm and a minimum width of at least 1 mm.

11. A lighting device according to claim 4, wherein said powder comprises calcium halophosphate, calcium pyrophosphate, BaSO₄, MgO, YBO₃, TiO₂ or Al₂O₃ particles.

12. A lighting device according to claim 11, wherein said particles have an average diameter ranging from 0.1 to 100 μm, in particular from 5 to 20 μm.

13. A lighting device according to claim 11, wherein said particles are mixed with fine-grained Al₂O₃ particles having an average diameter which ranges from 10 to 50 nm.

14. A lighting device according to claim 13, wherein the amount of fine-grained Al₂O₃ particles having an average diameter ranging from 10 to 50 nm ranges from 0.1 to 5 wt. %, in particular from 0.5 to 3 wt. %.

15. A lighting device according to claim 4, wherein said powder is a “free-flowing” type powder.

16. A lighting device according to claim 4, wherein the powder is substantially incapable of absorbing light, in particular light having a wavelength in the visible wavelength range.

17. A method for the lateral homogenisation of the intensity of the light emitted from a lighting housing, using a lighting device comprising at least one light source arranged in a housing for emitting a lighting beam through a light-transmitting plate of the housing, wherein said plate is locally provided with means which reflect incident light on the plate, in such a manner that light which locally has a higher intensity is reflected more strongly at that location than light which locally has a lower intensity, characterized in that said means comprise at least one light-transmitting plate, which is locally provided with a reflective material which reflects more than 80% of the incident light thereon, and wherein the patterned material has been rendered visually indistinguishable by disposing an additional translucent plate, for example a matted plate, on the side of the light-transmitting plate facing away from the light source, spaced from said light-transmitting plate by a short distance and oriented in parallel thereto.
